(19) United States
(12) Patent Application Publication
(10) Pub. No.: US 2007/0229766 A1
(43) Pub. Date: Oct. 4, 2007

(54) Modulation Apparatus and Projector

(75) Inventor: Shoichi Uchiyama, Shimo Suwa (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/690,549

(22) Filed: Mar. 23, 2007

(30) Foreign Application Priority Data
Mar. 29, 2006 (JP) 2006-089881

(51) Int. Cl. G03B 21/14

(52) U.S. Cl. 353/20; 353/33

(57) ABSTRACT

A modulation apparatus is disclosed. The modulation apparatus includes: first light-modulating elements installed for each of a plurality of illumination lights, a combining unit that combines the illumination light modulated by the respective first light-modulating elements and outputs as combined light; and a second light-modulating element that modulates the combined light, wherein the combining unit includes two prisms each having a total reflection plane which totally reflects the illumination light entering at a predetermined angle and allowing the illumination light entering at an angle different from the predetermined angle, and a reflection plane that reflects the illumination light totally reflected by the total reflection plane to a predetermined optical path directed toward the second light-modulating element, and the total reflection plane of a predetermined prism and the reflection plane of another prism different from the predetermined prism are in abutment with each other.

### BACKGROUND

1. Technical Field

The present invention relates to a modulation apparatus and a projector.

2. Related Art

In recent years, improvement of image quality in electronic display devices such as LCDs (Liquid Crystal Display), EL (Electro-luminescence) displays, plasma displays; CRTs (Cathode Ray Tubes), projectors is remarkable, and devices having a performance which is comparable with a human visual performance is almost realized in resolution and color gamut. However, regarding a luminance dynamic range, its reproducible range is about 1 to 10² [nit], and the number of tones which is prevailing is 8-bit. As regards human visual sense, it is said that the luminance dynamic range which the human can sense at a time is about 10⁻² to 10⁴ [nit], and the luminance discriminating capability is 0.2 [nit], which corresponds to 12-bit in number of tones. When an image displayed on the current display device is viewed via the visual performance as such, since narrowness of the luminance dynamic range is conspicuous, and furthermore, the tones of shadowed portions or highlighted portions are not sufficient, the viewer feels that reality or powerful impact of the display image is not satisfactory.

In the field of CG (Computer Graphics) used, for example, in films or games, a movement to pursue reality of presentation by providing a luminance dynamic range or tone characteristics, which is close to the human visual sense, to display data (hereinafter, referred to as “HDR (High Dynamic Range) display data”) is prevailing. However, there is a problem that the performance of the display device which displays such display data is not sufficient, and hence expressiveness that a CG content originally has cannot be demonstrated sufficiently.

Furthermore, in a next OS (Operating System), for example, WCS (Windows® Color System) mounted to WINDOWS®—Vista®, employment of 16-bit color space is scheduled, and hence the dynamic range or the number of tones dramatically increase in comparison with the current 8-bit color space. Therefore, it is expected that demand for realization of the electronic display device of the high-dynamic range/high tone which can take advantage of the 16-bit color space.

Projecting type display devices (projectors) such as a liquid crystal protector or a DLP (Digital Light Processing, trademark) projector from among the display devices are display devices which are capable of big screen display, and are effective for reproducing reality or powerful impact of the display image. In this field, the following proposal is presented in order to solve the above-described problem.

So-called HDR (High Dynamic Range) display, in which a contrast ratio is improved by modulating illumination light from a light source twice by two light-modulating elements arranged in series on an optical path is proposed as a high dynamic range display device (For example, see JP-A-2005-250440).

In the HDR display as such, red illumination light, green illumination light and blue illumination light are modulated by a first light-modulating element and are combined using a cross dichroic prism, and the combined light is further modulated by a second light-modulating element.

The illumination light modulated by the first light-modulating element includes red image information, green image information, and blue image information, and is different in state from the illumination light before entering the first light-modulating element. Therefore, in the description below, the illumination light modulated by the first light-modulating element is referred to as “color modulated light” for distinction as a matter of convenience in the following description.

However, the cross dichroic prism is formed by bonding four triangle prisms. Therefore, it is necessary to bond the four triangle prisms with the apexes exactly aligned with each other, and increase in bonding accuracy is difficult. In generally, the bonding accuracy of the triangle prisms is on the order of 10 seconds. As a consequence, misalignment may arise in combining of the red modulated light, the green modulated light and the blue modulated light, which results in misalignment of an image of the red modulated light, an image of the green modulated light, and an image of the blue modulated light imaged on the second light-modulating element. Therefore, a combined image cannot be modulated in the second light-modulating element accurately, and hence deterioration of the display image occurs.

### SUMMARY

An advantage of some aspects of the invention is to improve alignment accuracy easily when combining a plurality of color modulated lights modulated in a first light-modulating element.

A modulation apparatus according to an aspect of the invention includes: first light-modulating elements installed for each of a plurality of illumination lights, a combining unit that combines the illumination light modulated by the respective first light-modulating elements and outputs as combined light; and a second light-modulating element that modulates the combined light, wherein the combining unit includes two prisms each having a total reflection plane which totally reflects the illumination light entering at a predetermined angle and allowing the illumination light entering at an angle different from the predetermined angle, and a reflection plane that reflects the illumination light totally reflected by the total reflection plane to a predetermined optical path directed toward the second light-modulating element, and the total reflection plane of a predetermined prism and the reflection plane of another prism different from the predetermined prism are in abutment with each other.

According to the modulation apparatus in the aspect of the invention, the prism which constitutes the combining unit includes the total reflection plane that totally reflects the illumination light entering at the predetermined angle and allows the illumination light entering at an angle different from the predetermined angle, and a reflection plane that reflects the illumination light totally reflected by the total reflection plane toward the second light-modulating element. A plurality of such the prisms constitute the combining unit. Therefore, by allowing the illumination light to enter the total reflection plane of one prism at the predetermined angle and allowing the illumination light to enter also the total reflection plane of another prism at the predetermined angle, the both illumination lights go out to the predetermined optical path directed toward the second light-modulating element. Consequently, the illumination light entering the one prism and the illumination light entering the other prism are combined.

In the modulation apparatus in accordance with the aspect of the invention, the combining unit is configured by arranging the prisms with the total reflection plane of the one prism and the reflection plane of the other prism in abutment with each other.

Even when the abutment state between the one prism and the other prism is misaligned in a boundary plane between the total reflection plane of the one prism and the reflection plane of the other prism, the illumination light goes out to the predetermined optical path by allowing the illumination light to enter the total reflection planes of the respective prisms at a predetermined angle. Therefore, even when the abutment state is misaligned in the boundary plane between the total reflection plane of the one prism and the reflection plane of the other prism, the illumination lights may be superimposed and combined accurately by correcting the relative position among the plurality of first light-modulating elements according to the amount of misalignment.

That is, according to the modulation apparatus in the aspect of the invention, when the one prism is brought into abutment with the another prism, misalignment in the boundary plane between the total reflection plane of the one prism and the reflection plane of the other prism is allowed.

Therefore, according to the modulation apparatus in the aspect of the invention, accuracy of superimposition when combining the plurality of illumination lights modulated by the first light-modulating element may be improved easily in comparison with the modulation apparatus in the related art which employs a cross dichroic prism as the combining unit. In this manner, by the improvement of the accuracy of superimposition of the plurality of illumination lights, the combined light may be modulated accurately by the second light-modulating element. Accordingly, with the modulation apparatus in accordance with the aspect of the invention, the image quality of the display image is improved.

Preferably, according to the modulation apparatus in the aspect of the invention, a phase difference member that changes the state of polarization of the illumination light is formed on the total reflection plane of the prism.

In this configuration, the state of polarization of the respective illumination lights may be changed, and hence the state of polarization of the combined light may be controlled. For example, there is a case in which the state of polarization of the illumination light is disordered in a course of passing through the interior of the combining unit. However, by employing a phase compensating film that corrects the disorder of the polarization of the illumination light as the phase difference member, the disorder of the polarization of the illumination light going out to the predetermined optical path may be corrected.

Preferably, the phase difference member changes the state of polarization of the illumination light to bring the polarization of the combined light to a state corresponding to the second light-modulating element. Accordingly, the polarized state of the combined light may be brought into a state corresponding to the second light-modulating element. More specifically, for example, when the second light-modulating element is a transmissive type liquid crystal light valve, the combined light is prevented from being shielded by a polarizing plate on the incident side by matching the state of polarization of the combined light to a polarization axis of the polarizing plate on the incident side of the liquid crystal light valve. Therefore, the efficiency of illumination light utilization may be improved.

Preferably, the combining unit includes a prism having a combining plane having the total reflection plane and the reflection plane formed integrally.

In this manner, the total reflection plane and the reflection plane may be formed integrally.

A modulation apparatus according to another aspect of the invention includes first light-modulating elements installed for each of red illumination light, green illumination light and blue illumination light, a combining unit that combines the red illumination light, the green illumination light, and the blue illumination light modulated by the respective first light-modulating elements to output as combined light, and a second light-modulating element that modulates the combined light, wherein the combining unit includes a red illumination light prism having a total reflection plane which totally reflects the red illumination light incoming at a predetermined angle and allowing the red illumination light, the green illumination light, and the blue illumination light incoming at an angle different from the predetermined angle to pass through, and a reflection plane which reflects the red illumination light reflected totally by the total reflection plane to a predetermined optical path directed toward the second light-modulating element and allows the green illumination light and the blue illumination light to pass through, a blue illumination light prism having a total reflection plane which totally reflects the blue illumination light incoming at the predetermined angle and allows the blue illumination light and the green illumination light incoming at an angle different from the predetermined angle to pass through and a reflection plane that reflects the blue illumination light totally reflected by the total reflection plane to the predetermined optical path and allowing the green illumination light to pass through, and a green illumination light prism having a total reflection plane which totally reflects the green illumination light incoming at the predetermined angle to the predetermined optical path and a transmissive plane that allows the green illumination light totally reflected by the total reflection plane to pass through, wherein the total reflection plane of the blue illumination light prism and the reflection plane of the red illumination light prism are in abutment with each other, the reflection plane of the blue illumination light prism and the transmissive plane of the green illumination light prism are in abutment with each other, and the green illumination light prism and the red illumination light prism are not in abutment with each other.

According to the modulation apparatus in the aspect of the invention, all the illumination lights go out to the predetermined optical path directed toward the second light-modulating element by allowing the red illumination light to enter the total reflection plane of the red illumination light prism at the predetermined angle, allowing the green illumination light to enter the total reflection plane of the green illumination light prism at the predetermined angle, and allowing the blue illumination light to enter the total reflection plane of the blue illumination light prism at the predetermined angle. Consequently, the red illumination light, the green illumination light, and the blue illumination light are combined.

According to the modulation apparatus in the aspect of the invention, the combining unit is configured in such a manner that the total reflection plane of the blue illumination light prism and the reflection plane of the red illumination light prism are in abutment with each other, the reflection plane of the blue illumination light prism and the transmissive plane of the green illumination light prism are in abutment with each other, and the green illumination light prism and the red illumination light prism are not in abutment with each other.

Here, even when abutment between the blue illumination light prism and the red illumination lit prism is misaligned in a boundary plane between the total reflection plane and the reflection plane, the respective illumination lights go out to the predetermined optical path by allowing the respective illumination lights to enter the total reflection planes of the respective prisms at the predetermined angle. Therefore, even when the abutment is misaligned in a boundary plane between the total reflection plane of the blue illumination light prism and the reflection plane of the red illumination light prism, the blue illumination light and the red illumination light may be superimposed accurately by correcting the relative position between the first light-modulating element for blue color and the first light-modulating element for red color according to the amount of misalignment. The green illumination light prism and the blue illumination light prism are the same.

Since the green illumination light prism and the red illumination light prism are arranged without being in abutment with each other, in the modulation apparatus in accordance with the aspect of the invention, when the one prism is brought into abutment with the other prism, misalignment in the boundary plane between the total reflection plane of the one prism and the reflection plane of the other prism is allowed.

Therefore, according to the modulation apparatus in the aspect of the invention, accuracy of superimposition when combining the red illumination light, the green illumination light, and the blue illumination light modulated by the first light-modulating element may be improved easily in comparison with the modulation apparatus in the related art which employs a cross dichroic prism as the combining unit. In this mariner, by the improvement of the accuracy of superimposition of the red illumination light, the green illumination light, and the blue illumination light, the combined light may be modulated accurately by the second light-modulating element. Accordingly, with the modulation apparatus in accordance with the aspect of the invention, the image quality of the display image is improved.

A modulation apparatus according to another aspect of the invention includes first light-modulating elements installed for each of red illumination light, green illumination light and blue illumination light, a combining unit that combines the red illumination light, the green illumination light, and the blue illumination light modulated by the respective first light-modulating elements to output as combined light, and a second light-modulating element that modulates the combined light, wherein the combining unit includes a blue illumination light prism having a total reflection plane which totally reflects the blue illumination light incoming at a predetermined angle and allowing the blue illumination light, the green illumination light, and the red illumination light incoming at an angle different from the predetermined angle to pass through, and a reflection plane which reflects the blue illumination light reflected totally by the total reflection plane to a predetermined optical path directed toward the second light-modulating element and allows the green illumination light and the red illumination light to pass through, a red illumination light prism having a total reflection plane which totally reflects the red illumination light incoming at the predetermined angle and allows the red illumination light and the green illumination light incoming at an angle different from the predetermined angle to pass through and a reflection plane that reflects the red illumination light totally reflected by the total reflection plane to the predetermined optical path and allowing the green illumination light to pass through, and a green illumination light prism having a total reflection plane which totally reflects the green illumination light incoming at the predetermined angle to the predetermined optical path and a transmissive plane that allows the green illumination light totally reflected by the total reflection plane to pass through, wherein the total reflection plane of the red illumination light prism and the reflection plane of the blue illumination light prism are in abutment with each other, the reflection plane of the red illumination light prism and the transmissive plane of the green illumination light prism are in abutment with each other, and the green illumination light prism and the blue illumination light prism are not in abutment with each other.

According to the modulation apparatus in the aspect of the invention, all the illumination lights go out to the predetermined optical path directed toward the second light-modulating element by allowing the blue illumination light to enter the total reflection plane of the blue illumination light prism at the predetermined angle, allowing the green illumination light to enter the total reflection plane of the green illumination light prism at the predetermined angle, and allowing the red illumination light to enter the total reflection plane of the red illumination light prism at the predetermined angle. Consequently, the blue illumination light, the green illumination light, and the red illumination light are combined.

According to the modulation apparatus in the aspect of the invention, the combining unit is configured in such a manner that the total reflection plane of the red illumination light prism and the reflection plane of the blue illumination light prism are in abutment with each other, the reflection plane of the red illumination light prism and the transmissive plane of the green illumination light prism are in abutment with each other, and the green illumination light prism and the blue illumination light prism are not in abutment with each other.

Here, even when abutment between the red illumination light prism and the blue illumination light prism is misaligned in a boundary plane between the total reflection plane and the reflection plane, the respective illumination lights go out to the predetermined optical path by allowing the respective illumination lights to enter the total reflection planes of the respective prisms at the predetermined angle. Therefore, even when the abutment is misaligned in a boundary plane between the total reflection plane of the red illumination light prism and the reflection plane of the blue illumination light prism, the red illumination light and the blue illumination light may be superimposed accurately by correcting the relative position between the first light-modulating element for red color and the first light-modulating element for blue color according to the amount of misalignment. The green illumination light prism and the red illumination light prism are also the same.

Since the green illumination light prism and the blue illumination light prism are arranged without being in abutment with each other, in the modulation apparatus in accordance with the aspect of the invention when the one prism is brought into abutment with the other prism, misalignment in the boundary plane between the total reflection plane of the one prism and the reflection plane of the other prism is allowed.

Therefore, according to the modulation apparatus in the aspect of the invention, accuracy of superimposition when combining the blue illumination light, the green illumination light and the red illumination light modulated by the first light-modulating element may be improved easily in comparison with the modulation apparatus in the related art which employs a cross dichroic prism as the combining unit. In this manner, by the improvement of the accuracy of superimposition of the blue illumination light, the green illumination light, and the red illumination light, the combined light may be modulated accurately by the second light-modulating element. Accordingly, with the modulation apparatus in accordance with the aspect of the invention, the image quality of the display image is improved.

A projector according to another aspect of the invention is a projector that projects combined light going out from a modulation apparatus onto a display surface by a protecting unit in an enlarged scale, wherein the modulation apparatus in accordance with the aspect of the invention is employed as the modulation apparatus.

With the modulation apparatus in accordance with the aspect of the invention, the combined light may be accurately modulated by a second light-modulating element. Therefore, according to the projector provided with the modulation apparatus in accordance with the aspect of the invention, the image quality of the display image is improved.

### BRIEF DESCRIPTION OF THE DRAWINGS

The Invention will be described with reference to the accompanying drawings, wherein like numbers reference like elements.

FIG. 1 is a schematic configuration drawing showing an optical system of a projector in an embodiment of the invention.

FIG. 2 is an enlarged drawing of a combining prism.

### DESCRIPTION OF EXEMPLARY EMBODIMENTS

Referring now to the drawings, a modulation apparatus and a projector according to an embodiment of the invention will be described. In the following drawings, contraction scale of respective members is changed as needed in order to show the respective members in a recognizable scale.

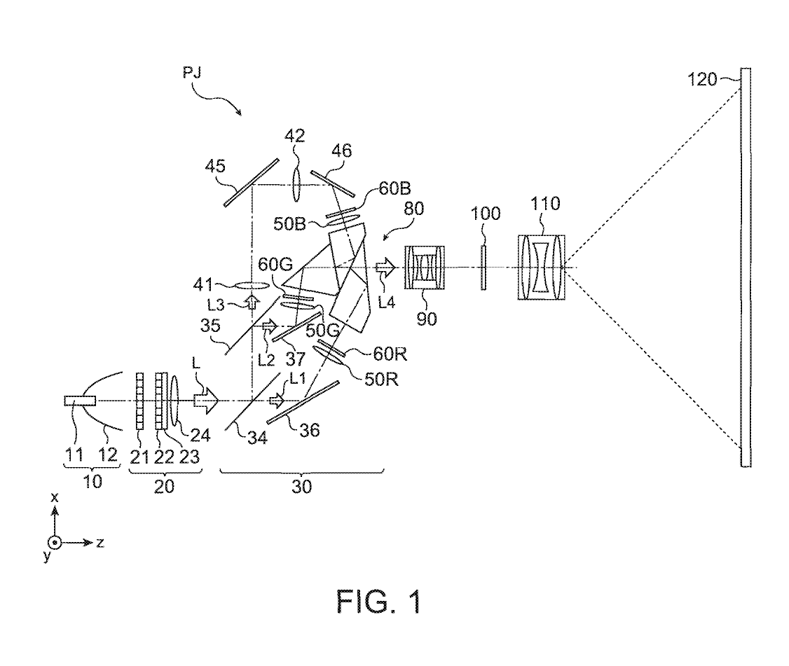

FIG. 1 is a schematic configuration drawing showing an optical system of the projector in this embodiment. A projector PJ in this embodiment includes a light source device 10, a uniform illumination system 20 for uniformizing the distribution of luminance of light (illumination light) incoming from the light source device 10, a color modulating unit 30 that modulates luminance of RGB three primary colors in the wavelength area of light incoming from the uniform illumination system 20, a relay lens 90 that relays light incoming from the color modulating unit 30, a liquid crystal light valve 100 that modulates luminance of the entire wavelength area of light incoming from the relay lens 90, and a projection lens 110 that projects light incoming from the liquid crystal light valve 100 onto the screen 120.

In the description shown below, a xyz orthogonal coordinate system of the entire optical system, an xy—plane corresponds to a pixel plane of the liquid crystal light vale 100 and a z-direction corresponds to the direction of light going out from the color combining prism 80 and proceeding toward the projection lens 110.

The light source device 10 includes a lamp 11 such as an extra—high pressure mercury lamp or xenon lamp, and a reflector 12 for reflecting and condensing outgoing light from the lamp 11, and the outgoing light emitted from the lamp 11 is reflected and condensed by the reflector 12 and is outputted as an illumination light L.

The uniform illumination system 20 includes first and second lens arrays 21 and 22 formed of, for example, a fly-eye lens, a polarization converting device 23, and a condenser lens 24. The distribution of luminance of the illumination light L emitted from the light source device 10 is uniformized by the first and second lens arrays 21 and 22, and the light passed through the first and second lens arrays 21 and 22 is polarized by the polarization converting device 23 in the direction that allows the light to enter the color modulating unit 30, and the polarized light is condensed by, for example, the condenser lens 24 and output to the color modulating unit 30. The polarization converting device 23 includes, for example, a PBS array and a ½ wave plate, for converting a random polarization into a specific linear polarization.

The color modulating unit 30 includes two dichroic mirrors 34 and 35 as light-separating device, four mirrors (reflection mirrors 36, 37, 45 and 46), five field lens (a lens 41, a relay lens 42, collimator lenses 50B, 50G and 50R), three liquid crystal light valves 60B, 60G and 60R, and a color combining prism 80.

The dichroic mirrors 34 and 35 separate the illumination light L from the light source device 10 into the RGB three primary color lights; red illumination light L1, green illumination light L2, and blue illumination light L3. The dichroic mirror 34 includes a glass plate and a dichroic film which is formed on the glass plate and has a property to reflect the green illumination light L2 and the blue illumination light L3 and transmits the red illumination light L1, and reflects the green illumination light L2 and the blue illumination light L3 and transmits the red illumination light L1. The dichroic mirror 35 includes a glass plate and a dichroic film which is formed on the glass plate and has a property to reflect the green illumination light L2 and transmit the blue illumination light L3, and reflects the green illumination light L2 from between the green illumination light L2 and the blue illumination light L3 reflected by the dichroic mirror 34 and guides the same to the collimator lens 50G, and transmits the blue illumination light L3 and guides the same to the lens 41.

The relay lens 42 guides the blue illumination light L3 to the position in the vicinity of the collimator lens 50B. The lens 41 has a function to allow light to enter the relay lens 42 efficiently. Then, the blue illumination light L3 entering the lens 41 is guided to the liquid crystal light valve 60B (first light-modulating element) which is spatially apart therefrom in a state in which the distribution of intensity thereof is substantially maintained as is with little loss of light.

The collimator lenses 50B, 50G and 50R substantially have a function to collimate color lights entering the corresponding liquid crystal light valves 60B, 60G and 60R, and allow light passing through the liquid crystal light valves 60B, 60G and 60R to enter a relay lens 90 efficiently. The red illumination light L1, the green illumination light L2, and the blue illumination light L3 separated by the dichroic mirrors 34 and 35 enter the liquid crystal light valves 60B, 60G and 60R via the mirror (the reflection mirrors 36, 37, 45 and 46) and the lenses (the lens 41, the relay lens 42, the collimator lenses 50B, 50G and 50R).

The reflection mirror 36 reflects the red illumination light L1 so that the red illumination light L1 enters a total reflection plane 81R of a red illumination light prism 80R of the color combining prism 80, described later, at a total reflection angle (a predetermined angle).

The reflection mirror 37 reflects the green illumination light L2 so that the green illumination light L2 enters a total reflection plane 81G of a green illumination light prism 50G of the color combining prism 80, described later, at a total reflection angle (a predetermined angle).

The reflection mirror 46 reflects the blue illumination light L3 so that the blue illumination light L3 enters a total reflection plane 81B of a blue illumination light prism 80B of the color combining prism 80, described later, at a total reflection angle (a predetermined angle). The reflection mirror 45 guides the blue illumination light L3 to the reflection mirror 46.

The liquid crystal light valves 60B, 60G and 60R are active matrix type liquid crystal display devices each include a glass substrate formed with pixel electrodes and switching elements for driving the same, such as thin film transistor elements or thin film diodes formed in a matrix pattern, a glass substrate formed with a common electrode on the entire surface thereof, TN-type liquid crystal sandwiched between these glass substrates, and a polarizing plate arranged on the outer surface thereof.

The liquid crystal light valves 60B, 60G and 60R are driven in a normally white mode in which a white/bright (transmissive) state is achieved when a voltage is not applied and a black/dark (non-transmissive) state is achieved when the voltage is applied, or in a normally black mode which acts inversely, and the tones between bright and dark are controlled analogously according to a given control value. The liquid crystal light valve 60B modulates the incoming blue illumination light L3 on the basis of the display image data and outputs the same as blue modulated light. The liquid crystal light valve 60G modulates the incoming green illumination light L2 on the basis of the display image data and outputs the same as green modulated light. The liquid crystal light valve 60R modulates the incoming red illumination light L1 on the basis of the display image data and outputs the same as red modulated light.

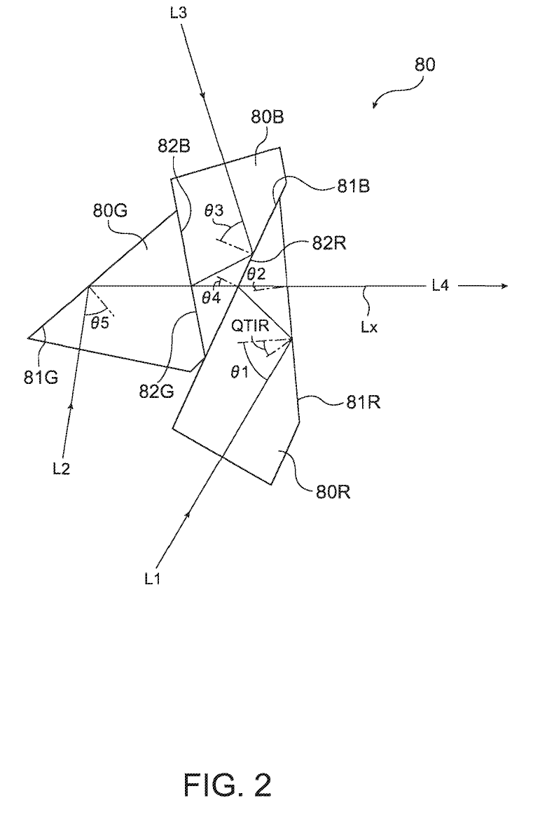

FIG. 2 is an enlarged drawing of the color combining prism 80. As shown in this drawing, the color combining prism 80 includes the red illumination light prism 80R, the green illumination light prism 80G, and the blue illumination light prism 80B.

The red illumination light prism 80R includes the total reflection plane 81R which totally reflects red modulated light L1 incoming at an incident angle θ1 which is larger than a critical angle θTIR and transmits the red modulated light L1 incoming at an incident angle θ2 which is smaller than the critical angle θTIR, and a reflection plane 82R which reflects the red modulated light L1 totally reflected by the total reflection plane 81R to an optical path LX (predetermined optical path) directed toward the liquid crystal light valve 100. The total reflection plane 81R and the reflection plane 82R transmit green modulated light L2 and blue modulated light L3.

The reflection plane 82R includes a dichroic film which reflects the red modulated light L1 toward the optical path LX and transmits the green modulated light L2 and the blue modulated light L3 formed on a surface of the red illumination light prism 80R. The dichroic film may be formed on the total reflection plane 81B of the blue illumination light prism, described later.

The total reflection plane 81R is formed with a phase compensating film 83R. The phase compensating film 83R is a film that changes a polarizing plate of the red modulated light L1 so that disorder of the polarization of the red modulated light L1 caused by being reflected by the reflection plane 82R is cancelled when going out from the color combining prism 80.

The blue illumination light prism 80B includes the total reflection plane 81B which totally reflects the blue modulated light L3 incoming at an incident angle θ3 which is larger than the critical angle θTIR and transmits the blue modulated light L3 incoming at an incident angle θ4 which is smaller than the critical angle θTIR, and a reflection plane 82B which reflects the blue modulated light L3 totally reflected by the total reflection plane 81B to the optical path LX (predetermined optical path.) directed toward the liquid crystal light valve 100. The total reflection plane 81B and the reflection plane 82B transmit the green modulated light L2. The reflection plane 82B is formed by forming a dichroic film which reflects the blue modulated light L3 toward the optical path LX and allows the green modulated light L2 to pass through on a surface of the blue illumination light prism 80B. The dichroic film may be formed on a transmissive plane 82G of the green illumination light prism, described later.

The total reflection plane 81B is formed with a phase compensating film 83B. The phase compensating film 83B is a film that changes a polarizing plate of the blue modulated light L3 so that disorder of the polarization of the blue modulated light L3 caused by being reflected by the reflection plane 82B and passing through the reflection plane 82R of the red illumination light prism 80R is cancelled when going out from the color combining prism 80.

The green illumination light prism 80G includes the total reflection plane 81G which totally reflects the green modulated light L2 incoming at an incident angle θ5 which is larger than the critical angle θTIR toward the optical path LX and a transmissive plane 82G which transmits the green modulated light L2 totally reflected by the total reflection plane 81G.

The total reflection plane 810 is formed with a phase compensating film 83G. The phase compensating film 83G is a film that changes a polarizing plate of the green modulated light L2 so that disorder of the polarization of the green modulated light L2 caused by passing through the reflection plane 82R of the red illumination light prism 83R and the reflection plane 82B of the blue illumination light prism is cancelled when going out from the color combining prism 80.

As shown in FIG. 2, the color combining prism 80 has a configuration such that the total reflection plane 81B of the blue illumination light prism 80B and the reflection plane 82R of the red illumination light prism 80R come into abutment with each other, and the reflection plane 82B of the blue illumination light prism 80B and the transmissive plane 82G of the green illumination light prism 80G come into abutment with each other. The green illumination light prism 83G and the red illumination light prism 80R are not in abutment with each other.

In the color combining prism 80 configured in this manner, even when the abutment state between the blue illumination light prism 80B and the red illumination light prism 80R is misaligned in a boundary plane between the total reflection plane 81B and the reflection plane 82R, the respective color modulated lights L1 and L3 go out to the optical path Lx by allowing the red modulated light L1 and the blue modulated light L3 to enter the total reflection planes 81R and 82B of the respective prisms 80R and 80B at a total reflection angle. Therefore, even when the total reflection plane 81B of the blue illumination light prism 80B and the reflection plane 82R of the red illumination light prism 80R are misaligned in the boundary plane, the red modulated light and the blue modulated light can be superimposed accurately by correcting the relative positional relationship between the liquid crystal light valves 60R and 60B according to the amount of misalignment.

Likewise, even when the abutment state between the blue illumination light prism 80B and the green illumination light prism 80G is misaligned in a boundary plane between the total reflection plane 81B and the transmissive plane 82G, the respective color modulated lights L2 and L3 go out to the optical path LX by allowing the green modulated light L2 and the blue modulated light L3 to enter the total reflection planes 81G and 82B of the respective prisms 80G and 80B at a total reflection angle. Therefore, even when the total reflection plane 81B of the blue illumination light prism 80B and the transmissive plane 82G of the green illumination light prism 80G is misaligned in the boundary plane, the blue modulated light and the green modulated light can be superimposed accurately by correcting the relative positional relationship between the liquid crystal light valves 60B and 60G according to the amount of misalignment.

The green illumination light prism 80G and the red illumination light prism 80R are arranged so as not to abut against each other. Therefore, for example, when the blue illumination light prism 80B is brought into abutment with the red illumination light prism 80R, the misalignment of the red illumination light prism is allowed in the boundary plane between the total reflection plane 81B and the reflection plane 82R.

Therefore, when forming the color combining prism 80, high positioning accuracy of the respective prisms is not required in comparison with a case of forming a cross dichroic prism formed by aligning the apexes of four triangle prisms aligned with each other. Nevertheless, the color combining prism 80 is able to superimpose the respective color modulated lights L1 to L3 with higher degree of accuracy than the cross dichroic prism.

Incident angles of the respective color modulated lights L1 to L3 to the total reflection planes 81R, 81G and 81B of the respective prisms 80R, 80G and SOB may be changed easily by adjusting the angles of the reflection mirrors 36, 37 and 46.

The relay lens 90 guides combined light L4 combined in the color combining prism 80 to the liquid crystal light valve 100. The relay lens 90 preferably has a telecentric property on both sides considering the angle-of-visibility property of the liquid crystal.

The liquid crystal light valve 100 modulates the luminance of the combined light L4 on the basis of the display image data and outputs the same to the projection lens 110.

The projection lens 110 displays a color image by projecting an optical image formed on the display surface of the liquid crystal light valve 100 on to the screen 120.

The liquid crystal light valves 60B, 60G and 60R, are the same as the liquid crystal valve 100 in a point that the intensity of the transmitted light is modulated. However, the former is different from the latter in such a manner that the liquid crystal light valve 100 modulates the combined light L4, which is light in the entire wavelength area, while the liquid crystal light valves 60B, 60G and 60R modulate light in a specific wavelength area (the red illumination light L1, the green illumination light L2 and the blue illumination light L3) which is separated by the dichroic mirrors 34 and 35. Therefore, as a matter of convenience, light intensity modulation done by the liquid crystal light valves 60B, 60G and 60R is refereed to as “color modulation”, and the light intensity modulation done by the liquid crystal light valve 100 is referred to as “luminance modulation” for distinction

Subsequently, the operation of the projector PJ will be described.

The illumination light L from the light source device 10 is separated into three primary color lights, that is, the red illumination light L1, the green illumination light L2, and the blue illumination light L3 by the dichroic mirrors 34 and 35, and enters into the liquid crystal light valves 60B, 60G and 60R via lenses and mirrors including the collimator lenses 50B, 50G and 50R. The respective illumination lights entering the liquid crystal light valves 60B, 60G and 60R are modulated in color on the basis of external data according to the respective wavelength areas, and are outputted.

The red modulated light L1 modulated in color by the liquid crystal light valve 60R enters the total reflection plane 81R of the red illumination light prism 80R at the incident angle θ1 which is larger than the critical angle θTIR and is totally reflected. The red modulated light L1 totally reflected by the total reflection plane 81R is reflected by the reflection plane 82R of the red illumination light prism 80R toward the optical path LX and then enters the total reflection plane 81R at the incident angle θ2 which is smaller than the critical angle θTIR, thereby passing through the total reflection plane 81R and going out to the optical path LX.

The blue modulated light L3 modulated in color by the liquid crystal light valve 60B enters the total reflection plane 81B of the blue illumination light prism 80B at the incident angle θ3 which is larger than the critical angle θTIR and is reflected totally. The blue modulated light L3 totally reflected by the total reflection plane 81B is reflected by the reflection plane 82B of the blue illumination light prism 80B toward the optical path LX, passes through the total reflection plane 81B by entering the total reflection plane 81B at the incident angle θ4 which is smaller than the critical angle TIR, then passes through the total reflection plane 81R and the reflection plane 82R of the red illumination light prism 80R, and then goes out to the optical path LX.

The green modulated light L2 modulated in color by the liquid crystal light valve 60G is totally reflected toward the optical path LX by entering the total reflection plane 81G of the green illumination light prism 80G at the incident angle θ5 which is larger than the critical angle θTIR. The green modulated light L2 totally reflected by the total reflection plane 81G passes through the reflection plane 82B of the blue illumination light prism 80B, the total reflection plane 81B of the blue illumination light prism 80B, the reflection plane 82R of the red illumination light prism 80R and the total reflection plane 81R of the red illumination light prism 80R in sequence, and goes out to the optical path LX.

In this manner, the respective color modulated lights L1 to L3 entering the color combining prism 80 all go out to the optical path LX. Consequently, the respective color modulated lights L1 to L3 are superimposed and combined, and the combined light L4 goes out from the color combining prism 80.

The total reflection plane 81R of the red illumination light prism 80R is formed with the phase compensating film 83R that corrects disorder of the polarization of the red modulated light L1, the total reflection plane 81B of the blue illumination light prism 80B is formed with the phase compensating film 83B that corrects disorder of the polarization of the blue modulated light L3, and the total reflection plane 81G of the green illumination light prism 80G is formed with the phase compensating film 83G. Therefore, the polarization of the color modulated lights L1 to L3 going out from the respective prisms 80R, 80G and 80B are brought into a well-ordered state and hence the polarization of the combined light L4 is also a well-ordered state.

Then, the combined light L4 going out from the color combining prism 80 enters the liquid crystal light valve 100 via the relay lens 90. The combined light L4 entering the liquid crystal light valve 100 is modulated in luminance on the basis of the external data according to the entire wavelength area and goes out to the projection lens 110 as modulated light including a final optical image. Then, the combined light L4 is enlarged in the projection lens 110 and projected on the screen 120, whereby an image is displayed on the screen 120.

According to the projector PJ in this embodiment, the color combining prism 80 which can superimpose illumination lights more easily and more reliably than the cross dichroic prism is employed as a combining unit. Therefore, accuracy of superimposition of the red modulated light L1, the green modulated light L2, and the blue modulated light L3 is improved. In this manner, by the improvement of the accuracy of superimposition of the red modulated light L1 the green modulated light L2, and the blue modulated light L3, the combined light L4 may be modulated accurately by the liquid crystal light valve 100. Therefore, according to the projector PJ of this embodiment, the quality of the display image on the screen 120 may be improved.

According to the projector PJ in this embodiment, the polarization of the combined light L4 is brought into a well-ordered state by the phase compensating film 83R formed on the total reflection plane 81R of the red illumination light prism 80R, the phase compensating film 83B formed on the total reflection plane 81B of the blue illumination light prism 80B, and the total reflection plane 81G of the green illumination light prism 80G. Therefore, components shielded by the polarizing plate of the liquid crystal light valve 100 when the combined light L4 enters the liquid crystal light valve 100 is reduced, and hence the efficiency of illumination light utilization is improved and, simultaneously, the contrast characteristics of the display image may be improved since unnecessary polarized light is eliminated.

In this embodiment, the modulation apparatus in accordance with the embodiment of the invention includes the light source device 10, the uniform illumination system 20, the color modulating unit 30, the relay lens 90 and the liquid crystal light valve 100 (second light-modulating element).

Although preferred embodiments of the modulation apparatus and the projector have been described on the basis of the attached drawings, it is needless to say that the invention is not limited to the above-described embodiments. The shapes and combination of the respective components shown in the embodiments described above are illustrative only, and may be modified variously on the basis of design requirements without departing the scope of the invention.

For example, in the above-described embodiment, the green illumination light prism, the blue illumination light prism, and the red illumination light prism are arranged in sequence from the side of the light source as the combination of the color combining prism. However, for example, the illumination light prisms may be arranged in the order of the green illumination light prism, the red illumination light prism, and the blue illumination light prism.

In this case as well, the blue illumination light prism includes a total reflection plane which totally reflects the blue modulated light incoming at the predetermined angle and allowing the blue modulated light, the green modulated light and the red modulated light entering at an angle different from the predetermined angle to pass through, and a reflection plane which reflects the blue modulated light totally reflected by the total reflection plane to a predetermined optical path directed toward the liquid crystal light valve 100 and allows the green modulated light and the red modulated light to pass through.

The red illumination light prism includes a total reflection plane which totally reflects the red modulated light entering at the predetermined angle and allows the red modulated light and the green modulated light entering at an angle different from the predetermined angle to pass through, and a reflection plane which reflects the red modulated light totally reflected by the total reflection plane to the predetermined optical path and allows the green modulated light to pass through.

The green illumination light prism includes a total reflection plane which totally reflects the green modulated light entering at the predetermined angle, and a transmissive plane which transmits the green modulated light totally reflected by the total reflection plane.

In the embodiment shown above, the transmissive liquid crystal light valve is employed as the light-modulating element. However, the invention is not limited thereto, and a reflective type liquid crystal light valve or a minute mirror array device may also be employed as the light-modulating element.

In the embodiment shown above, the projection lens is employed as a projecting unit. However, the invention is not limited hereto, and a projection mirror may be used as the protecting unit.

For example, it is also possible to apply a so called rear projector in which the screen in the above-described embodiment is installed so as to be exposed from a part of a case, other structures other than the screen in the above-described embodiment are stored in the case, and images are displayed by projecting the same from the interior of the case onto the screen from the rear.

The entire disclosure of Japanese Patent Application No. 2006-089881, filed Mar. 29, 2006 is expressly incorporated by reference herein.

What is claimed is:

1. A modulation apparatus comprising:
first light-modulating elements installed for each of a plurality of illumination lights,
a combining unit that combines the illumination light modulated by the respective first light-modulating elements and outputs as combined light; and
a second light-modulating element that modulates the combined light,
wherein the combining unit includes two prisms each having a total reflection plane which totally reflects the illumination light entering at a predetermined angle and allowing the illumination light entering at an angle different from the predetermined angle, and a reflection plane that reflects the illumination light totally reflected by the total reflection plane to a predetermined optical path directed toward the second light-modulating element, and the total reflection plane of a predetermined prism and the reflection plane of another prism different from the predetermined prism are in abutment with each other.

2. The modulation apparatus according to claim 1, wherein a phase difference member that changes the state of polarization of the illumination light is formed on the total reflection plane of the prism.

3. The modulation apparatus according to claim 2, wherein the phase difference member changes the state of polarization of the illumination light to bring the polarization of the combined light to a state corresponding to the second light-modulating element.

4. The modulation apparatus according to claim wherein the combining unit includes a prism having a combining plane having the total reflection plane and the reflection plane formed integrally.

5. A modulation apparatus comprising:
first light-modulating elements installed for each of red illuminant on light, green illumination light and blue illumination light,
a combining unit that combines the red illumination light, the green illumination light, and the blue illumination light modulated by the respective first light-modulating elements to output as combined light, and
a second light-modulating element that modulates the combined light,
wherein the combining unit includes:
a red illumination light prism having a total reflection plane which totally reflects the red illumination light incoming at a predetermined angle and allowing the red illumination light, the green illumination light, and the blue illumination light incoming at an angle different from the predetermined angle to pass through, and a reflection plane which reflects the red illumination light reflected totally by the total reflection plane to a predetermined optical path directed toward the second light-modulating element and allows the green illumination light and the blue illumination light to pass through;
a blue illumination light prism having a total reflection plane which totally reflects the blue illumination light incoming at the predetermined angle and allows the blue illumination light and the green illumination light incoming at an angle different from the predetermined angle to pass through and a reflection plane that reflects the blue illumination light totally reflected by the total reflection plane to the predetermined optical path and allowing the green illumination light to pass through; and
a green illumination light prism having a total reflection plane which totally reflects the green illumination light incoming at the predetermined angle to the predetermined optical path and a transmissive plane that allows the green illumination light totally reflected by the total reflection plane to pass through,
wherein the total reflection plane of the blue illumination light prism and the reflection plane of the red illumination light prism are in abutment with each other, the reflection plane of the blue illumination light prism and the transmissive plane of the green illumination light prism are in abutment with each other, and the green illumination light prism and the red illumination light prism are not in abutment with each other.

6. A modulation apparatus comprising:
first light-modulating elements installed for each of red illumination light, green illumination light and blue illumination light;
a combining unit that combines the red illumination light, the green illumination light, and the blue illumination light modulated by the respective first light-modulating elements to output as combined light, and
a second light-modulating element that modulates the combined light,
wherein the combining unit includes:
a blue illumination light prism having a total reflection plane which totally reflects the blue illumination light incoming at a predetermined angle and allowing the blue illumination light, the green illumination light, and the red illumination light incoming at an angle different from the predetermined angle to pass through, and a reflection plane which reflects the blue illumination light reflected totally by the total reflection plane to a predetermined optical path directed toward the second light-modulating element and allows the green illumination light and the red illumination light to pass through,
a red illumination light prism having a total reflection plane which totally reflects the red illumination light incoming at the predetermined angle and allows the red illumination light and the green illumination light incoming at an angle different from the predetermined angle to pass through and a reflection plane that reflects the red illumination light totally reflected by the total reflection plane to the predetermined optical path and allowing the green illumination light to pass through, and
a green illumination light prism having a total reflection plane which totally reflects the green illumination light incoming at the predetermined angle to the predetermined optical path and a transmissive plane that allows the green illumination light totally reflected by the total reflection plane to pass through, and
wherein the total reflection plane of the red illumination light prism and the reflection plane of the blue illumination light prism are in abutment with each other, the reflection plane of the red illumination light prism and the transmissive plane of the green illumination light prism are in abutment with each other, and the green illumination light prism and the blue illumination light prism are not in abutment with each other.

7. A projector that projects combined light going out from a modulation apparatus onto a display surface by a projecting unit,
wherein the modulation apparatus according to claim 1 is employed as the modulation apparatus.

8. The projector according to claim 1, wherein a phase difference member that changes the state of polarization of the illumination light is formed on the total reflection plane of the prism.

9. The projector according to claim 2, wherein the phase difference member changes the state of polarization of the illumination light to bring the polarization of the combined light to a state corresponding to the second light-modulating element.

10. The projector according to claim 1, wherein the combining unit includes a prism having a combining plane having the total reflection plane and the reflection plane formed integrally.
